(19) United States
(12) Patent Application Publication
(10) Pub. No.: US 2013/0092618 A1
(43) Pub. Date: Apr. 18, 2013

(54) SEPARATION MEMBRANE, WATER TREATMENT UNIT AND WATER TREATMENT APPARATUS

(71) Applicant: SUMITOMO ELECTRIC INDUSTRIES, LTD., Osaka (JP)

(72) Inventors: Hideki KASHIHARA, Osaka (JP); Shuji HAHAKURA, Osaka (JP); Satoshi YAHAGI, Osaka (JP); Ryusuke NAKAI, Osaka (JP)

(73) Assignee: SUMITOMO ELECTRIC INDUSTRIES, LTD., Osaka (JP)

(21) Appl. No.: 13/649,349

(22) Filed: Oct. 11, 2012

Related U.S. Application Data
(60) Provisional application No. 61/546,744, filed on Oct. 13, 2011.

(30) Foreign Application Priority Data
Oct. 13, 2011 (JP) 2011-225557

(51) Int. Cl. C02F 1/44; B01D 65/02; B01D 69/02

(52) U.S. Cl. 210/321.69; 210/500.21

(57) ABSTRACT

A separation membrane is usable in a water treatment apparatus that performs water treatment using a reverse osmosis membrane. The separation membrane includes a plurality of island-like portions and a plurality of fiber-like portions extending from the island-like portions and having a width smaller than that of the island-like portions, and an area of the fiber-like portions at a membrane surface is set to be larger than that of the island-like portions. A water treatment unit includes: a casing; the aforementioned separation membrane mounted in the casing; and a cleaning device attached to the casing and capable of cleaning the separation membrane. The water treatment apparatus includes: a first water treatment unit capable of performing pretreatment of water to be treated; and a second water treatment unit capable of performing main treatment of the water to be treated. The first water treatment unit includes the aforementioned water treatment unit.

### BACKGROUND OF THE INVENTION

1. Field of the Invention

The present invention relates to a separation membrane, a water treatment unit including the separation membrane, and a water treatment apparatus including the water treatment unit.

2. Description of the Background Art

A water treatment apparatus using a reverse osmosis membrane has been conventionally known. When seawater is desalinated with this type of water treatment apparatus, pretreatment for removing suspended substances or organic particles such as TEP (Transparent Exopolymer Particles) from raw water is typically performed before treatment with the reverse osmosis membrane.

One example of a pretreatment apparatus usable in this pretreatment is described in, for example, Japanese Patent No. 4525857.

According to the pretreatment apparatus described in Japanese Patent No. 4525857, a large amount of treatment can be obtained with small installation area, and the organic particles can also be effectively removed. As schematically shown in FIG. 4, a separation membrane used in the pretreatment apparatus described in Japanese Patent No. 4525857 mainly includes an island-like node 5 and an ultrathin fiber-like fibril 6 connecting nodes 5.

The inventors of the present application earnestly studied a structure of the separation membrane that can effectively remove, in the pretreatment, saccharide and particularly saccharide swelled with water and jellified like TEP. As a result of their study, the inventors of the present application found that a ratio between nodes 5 and fibrils 6 affects a saccharide removal rate.

### SUMMARY OF THE INVENTION

Thus, an object of the present invention is to provide a separation membrane, a water treatment unit including the separation membrane, and a water treatment apparatus (water treatment system), in which a rate of removal of saccharide from water to be treated can be enhanced.

A separation membrane (filtration membrane) according to the present invention is usable in a water treatment apparatus that performs water treatment using a reverse osmosis membrane. The separation membrane includes: a plurality of island-like portions; and a plurality of fiber-like portions extending from the island-like portions and having a width smaller than that of the island-like portions, wherein an area of the fiber-like portions at a membrane surface is set to be larger than that of the island-like portions.

Preferably, in the separation membrane, a rate of removal of saccharide from water to be treated is 50% or more. In other words, the area of the fiber-like portions at the membrane surface is preferably set to be larger than that of the island-like portions such that the rate of removal of saccharide from the water to be treated becomes 50% or more. More preferably, the area of the fiber-like portions at the membrane surface is set to be three times or more, and further preferably five times or more, of that of the island-like portions.

A water treatment unit according to the present invention is usable in a water treatment apparatus that performs water treatment using a reverse osmosis membrane. The water treatment unit includes: a casing; a separation membrane mounted in the casing; and a cleaning device attached to the casing and capable of cleaning the separation membrane. The aforementioned separation membrane is used as the separation membrane.

Preferably, the cleaning device includes at least one of cleaning liquid supply means capable of supplying a cleaning liquid into the casing, ultrasonic wave supply means capable of supplying an ultrasonic wave to the separation membrane, and water flow/bubble flow supply means capable of supplying a water flow and/or a bubble flow to the separation membrane.

A water treatment apparatus (water treatment system) according to the present invention performs water treatment using a reverse osmosis membrane. The water treatment apparatus includes: a first water treatment unit capable of performing pretreatment of water to be treated; and a second water treatment unit capable of performing main treatment of the water to be treated. The aforementioned water treatment unit is used as the first water treatment unit and the aforementioned separation membrane is used as a separation membrane.

The inventors of the present application learned that by setting the area of the fiber-like portions at the membrane surface of the separation membrane to be larger than that of the island-like portions, i.e., configuring the separation membrane to be mainly composed of the fiber-like portions, the rate of removal of saccharide from the water to be treated can be enhanced. Therefore, by using the separation membrane according to the present invention, there can be obtained a water treatment unit and a water treatment apparatus (water treatment system) that are excellent in the rate of removal of saccharide from the water to be treated.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a water treatment apparatus (water treatment system) according to an embodiment of the present invention.

FIG. 2 is a cross-sectional view showing a water treatment unit according to the embodiment of the present invention.

FIG. 3(a) is a partially enlarged photograph of a surface of a separation membrane according to the embodiment of the present invention and FIG. 3(b) is a partially enlarged view of the photograph shown in FIG. 3(a).

FIG. 4 is a schematic view showing a structural example of a part of a surface of a conventional separation membrane.

### DESCRIPTION OF THE PREFERRED EMBODIMENTS

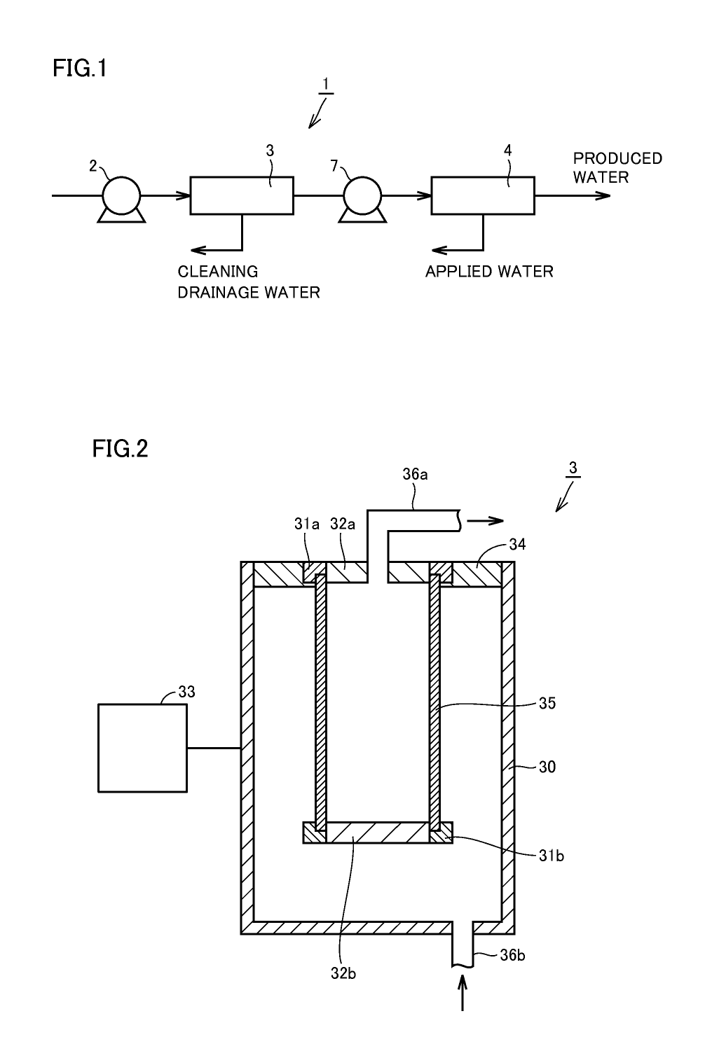

An embodiment of the present invention will be described hereinafter with reference to FIGS. 1 to 4.

A water treatment apparatus (water treatment system) 1 according to the present embodiment is an apparatus that performs water treatment using a reverse osmosis membrane. Water treatment apparatus 1 can be used to treat water such as seawater, groundwater and discharged water that contains various impurities, and is useful for seawater desalination treatment.

As shown in FIG. 1, water treatment apparatus 1 includes a pump 2, a first water treatment unit 3 capable of performing pretreatment of water to be treated, a second water treatment unit 4 capable of performing main treatment of the water to be treated, and a pump 7 providing water to the reverse osmosis membrane under high pressure. Pump 2 is arranged in the former stage of first water treatment unit 3, and pump 2 delivers the water to be treated in the direction shown by an arrow in the figure.

In water treatment apparatus 1 shown in FIG. 1, seawater, for example, is delivered into first water treatment unit 3 and passes through a separation membrane (filtration membrane) in first water treatment unit 3, and thereby the pretreatment is performed. As a result, organic particles and inorganic solids in the seawater are filtered and removed. The seawater that has been subjected to the pretreatment as described above is delivered into second water treatment unit 4 and passes through the reverse osmosis membrane (not shown) in second water treatment unit 4, and thereby desalting is performed. As a result, fresh water can be obtained from the seawater.

First water treatment unit 3 may be configured by a single unit or a plurality of units. In other words, a configuration of one-stage filtration may be used or a configuration of multiple-stage filtration in which filtration of two or more stages is performed may be used. For example, when two-stage filtration is used, it is conceivable to perform first filtration using a separation membrane having an average pore diameter of approximately several micrometers and second filtration using Microfiltration (MF) or Ultrafiltration (UF).

As shown in FIG. 2, first water treatment unit 3 includes a casing 30, a separation membrane 35 mounted in casing 30, and a cleaning device 33 attached to casing 30 and capable of cleaning separation membrane 35. Although hollow fibers and a membrane can be both used as separation membrane 35, the case where the membrane is used will now be described.

Casing 30 has, for example, a rectangular or cylindrical shape and can be made of any material as long as it has the required mechanical strength. In the example in FIG. 2, separation membrane 35 is mounted in casing 30 by a fixing member 34, with separation membrane 35 retained by retaining members 31a and 31b. The retaining members and the membrane are sealed and bonded by an adhesive sealant such as urethane and epoxy, to prevent leakage of water. Spacers 32a and 32b are attached to opposing ends of separation membrane 35 in the longitudinal direction so as to define a flow channel for the water to be treated inside separation membrane 35. The separation membrane elements including separation membrane 35 are mounted in casing 30 as described above. It is to be noted that a structure of retaining members 31a and 31b, spacers 32a and 32b, and fixing member 34 in the separation membrane elements is shown by way of example. Any configuration other than the configuration shown in FIG. 2 can be used as long as it can retain separation membrane 35 inside casing 30.

A pipe 36b is connected to one end of casing 30, and through this pipe 36b, seawater that is the water to be treated is delivered into first water treatment unit 3. At the other end of casing 30, a pipe 36a is connected to spacer 32a to penetrate through spacer 32a, and through this pipe 36a, the filtered seawater is discharged outside first water treatment unit 3.

Cleaning device 33 can include, for example, cleaning liquid supply means (not shown) capable of supplying a cleaning liquid into casing 30, ultrasonic wave supply means (not shown) capable of supplying an ultrasonic wave to separation membrane 35, water flow/bubble flow supply means (not shown) capable of supplying a water flow and/or a bubble flow to separation membrane 35, and the like. The water flow/bubble flow supply means can supply, for example, a jet water flow, a jet water flow including bubbles, and the like. These means may be used alone or in combination. The number and the placement position of these means can also be selected arbitrarily.

A well-known configuration can be used as the cleaning liquid supply means as long as it can supply the cleaning liquid into casing 30. Hypochlorous acid, a surfactant and the like can be used as the cleaning liquid, and particularly limonene (d-limonene: see the chemical formula 1 below)-containing water can be used. Approximately 30 ppm to 1000 ppm of the limonene-containing water is, for example, supplied to an inner region of separation membrane 35 to remove TEP, suspended substances and the like with which the membrane is clogged due to backwash. By supplying the limonene-containing water to the inner region of separation membrane 35 and doing backwash of separation membrane 35 as described above, clogging of separation membrane 35 can be effectively removed. Particularly, TEP entangled in the membrane can be floated and effectively removed.

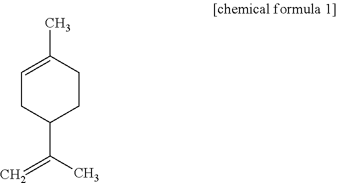

After the backwash with the limonene-containing water, rinse treatment with a slightly acidic solution such as a citric acid aqueous solution and an acetic acid aqueous solution or an alcohol solution such as an isopropyl alcohol aqueous solution and an ethanol aqueous solution is preferably performed. As a result, the quality of the water to be treated after the aforementioned backwash can be improved. Specifically, a value of SDI (Silt Density Index) can be decreased.

A well-known ultrasonic wave generating apparatus such as an ultrasonic vibrator can be used as the ultrasonic wave supply means. Ultrasonic waves (e.g., approximately 15 to 400 kHz) from the ultrasonic wave generating apparatus may be indirectly applied to separation membrane 35 through the water to be treated and the separation membrane elements in casing 30, or may be directly applied to separation membrane 35.

The water flow/bubble flow supply means can include various equipment and devices such as a nozzle capable of jetting a water flow and/or a bubble flow. A plurality of the water flow/bubble flow supply means may be arranged, for example, around separation membrane 35.

In water treatment apparatus 1 according to the present embodiment, second water treatment unit 4 performs desalting treatment. Second water treatment unit 4 includes the reverse osmosis membrane having a pore diameter of approximately 1 to 2 nm. The reverse osmosis membrane may be configured into a spiral-type or a tubular-type reverse osmosis membrane and may be formed of a hollow fiber membrane. Preferably, however, the reverse osmosis membrane has a structure that can treat a large amount of seawater.

Separation membrane 35 according to the present embodiment can be made of, for example, a hydrophobic polymer material such as fluorine resin and polyolefin. Fluorine resin can include polytetrafluoroethylene (PTFE), polyvinylidene fluoride (PVDF) and the like, and polyolefin can include polyethylene, other poly-α-olefin and the like. Particularly by using PTFE, there can be obtained a membrane having a highly-developed fibril structure.

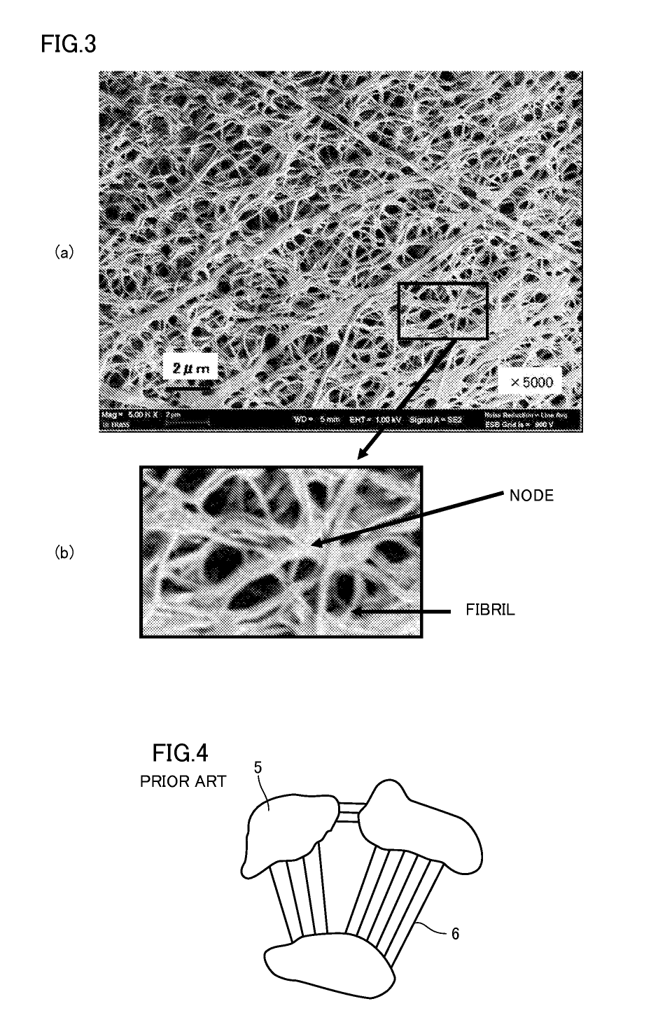

As shown in FIGS. 3(a) and 3(b), separation membrane 35 includes a node that is an island-like portion and a fiber-like fibril extending from the node and having a width smaller than that of the node. In the example in FIGS. 3(a) and 3(b), there are many nodes and fibrils, and some nodes extend long in a linear manner or in a curved manner. In the present invention, it is defined that the concept of the aforementioned “island-like portion” includes such nodes extending long in a linear manner or in a curved manner as well.

In separation membrane 35 according to the present embodiment, an area of the fibrils (fiber-like portions) at a membrane surface shown in, for example, FIGS. 3(a) and 3(b) is set to be larger than that of the nodes (island-like portions). In other words, separation membrane 35 is configured to be mainly composed of the fibrils. Preferably, the area of the fibrils is set to be three times or more, and more preferably five times or more, of that of the nodes. In the example in FIGS. 3(a) and 3(b), the area of the fibrils is about five times as large as that of the nodes. Since separation membrane 35 is configured to be mainly composed of the fibrils as described above, the rate of removal of saccharide from the water to be treated can be enhanced. For example, by appropriately adjusting the area of the fibrils and the area of the nodes at the surface of separation membrane 35, the rate of removal of saccharide from the water to be treated can be 50% or more. It is to be noted that the areas of the fibrils and the nodes may be measured, for example, on a taken microscope photograph of the surface of separation membrane 35.

Now, a method for measuring an amount of saccharide (saccharide amount) in the water to be treated will be described.

The saccharide amount can be measured by liquid chromatography of the concentrated water to be treated. Specifically, the saccharide amount can be determined based on a peak strength of saccharide of a chromatogram obtained by concentrating the water to be treated and hydrolyzing the obtained concentrated sample, and thereafter, analyzing the sample by liquid chromatography and particularly ion chromatography. The water to be treated can be concentrated using, for example, a method for remelting, with a small amount of pure water, the residue obtained after distilling away the water in the water to be treated and freeze-drying the water to be treated.

When ion chromatography is used, hydrolysis for changing polysaccharide in the water to be treated to monosaccharide is performed before determination by liquid chromatography. Filtration and centrifugal separation for removing suspended substances in the water to be treated, treatment with an ion-exchange resin for removing ions dissolved in the water to be treated, and the like may also be performed as other pretreatment.

In the case of ion chromatography with an anion-exchange resin, a mobile phase can include a sodium hydroxide solution and the like. Although a detector can include a differential refractometer and the like, an electrochemical detector is preferably used in the case of ion chromatography.

In the specification of the present application, “amount of saccharide (saccharide amount)” refers to a total amount of a rhamnose amount, a galactose amount, a glucose amount, and a mannose amount. “Saccharide removal rate” refers to a rate of decrease of a total amount of measurement values of a rhamnose amount, a galactose amount, a glucose amount, and a mannose amount with respect to “seawater (water to be treated)”.

Referring again to FIGS. 3(a) and 3(b), separation membrane 35 has many minute holes and these holes have an average pore diameter of, for example, 1 to 10 μm, and more preferably 2 to 5 μm. “Average pore diameter of separation membrane 35” herein refers to a pore diameter determined by the bubble point method (airflow method). Specifically, this pore diameter refers to diameter d (um) indicated by d=4Bγ/P, assuming that P (Pa) represents an IPA bubble point value (pressure) measured based on ASTM F316 by using isopropyl alcohol, γ represents the surface tension (dynes/cm) of the liquid, and B represents the capillary constant.

Next, a method for manufacturing aforementioned separation membrane 35 will be described. It is to be noted that a method for manufacturing separation membrane 35 made of PTFE will be described below.

For example, PTFE powders are prepared by emulsion polymerization and these powders are shaped into a membrane by extrusion. Thereafter, the membrane thus obtained is stretched and subjected to heat treatment. Separation membrane 35 can thus be manufactured. At this time, by appropriately adjusting conditions of extrusion and stretching of the PTFE powders, the average pore diameter, the mechanical strength and the like of separation membrane 35 can be adjusted. In addition, by adjusting conditions of the particle size, extrusion, stretching, and heat treatment of the PTFE powders, a ratio between the area of the fibrils and the area of the nodes can also be adjusted.

Next, an example of the present invention will be described.

### EXAMPLE 1

The inventors of the present application actually fabricated a hollow fiber membrane by extruding, stretching and sintering a PTFE resin. The hollow fiber membrane had a pore diameter of 2 μm and a thickness of 600 μm, and an area of fibrils at a surface of the hollow fiber membrane was three times as large as that of nodes. The surface property of this hollow fiber membrane was a hydrophobic membrane. When used, the membrane was wetted with isopropyl alcohol, and thereafter, was immersed in water to replace the isopropyl alcohol with water. The separation membrane in this state was used without being dried, to filter seawater.

Specifically, seawater obtained in Shizuoka Prefecture was filtered using this separation membrane. A filtration flux at this time was 10 m/d. As a result of analysis of a concentration of saccharide in the seawater and the filtered water, the saccharide removal rate was 62%.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A separation membrane usable in a water treatment apparatus that performs water treatment using a reverse osmosis membrane, comprising:
a plurality of island-like portions; and
a plurality of fiber-like portions extending from said island-like portions and having a width smaller than that of said island-like portions, wherein
an area of said fiber-like portions at a membrane surface is set to be larger than that of said island-like portions.

2. The separation membrane according to claim 1, wherein
the area of said fiber-like portions at said membrane surface is set to be three times or more of that of said island-like portions.

3. The separation membrane according to claim 1, wherein
a rate of removal of saccharide from water to be treated is 50% or more.

4. A water treatment unit usable in a water treatment apparatus that performs water treatment using a reverse osmosis membrane, comprising:
a casing;
a separation membrane mounted in said casing; and
a cleaning device attached to said casing and capable of cleaning said separation membrane, wherein
said separation membrane has a plurality of island-like portions and a plurality of fiber-like portions extending from said island-like portions and having a width smaller than that of said island-like portions, and an area of said fiber-like portions at a membrane surface is set to be larger than that of said island-like portions.

5. The water treatment unit according to claim 4, wherein
said cleaning device includes at least one of cleaning liquid supply means capable of supplying a cleaning liquid into said casing, ultrasonic wave supply means capable of supplying an ultrasonic wave to said separation membrane, and water flow/bubble flow supply means capable of supplying a water flow and/or a bubble flow to said separation membrane.

6. A water treatment apparatus that performs water treatment using a reverse osmosis membrane, comprising:
a first water treatment unit capable of performing pretreatment of water to be treated; and
a second water treatment unit capable of performing main treatment of the water to be treated,
said first water treatment unit including:
a casing;
a separation membrane mounted in said casing; and
a cleaning device attached to said casing and capable of cleaning said separation membrane, wherein
said separation membrane includes a plurality of island-like portions and a plurality of fiber-like portions extending from said island-like portions and having a width smaller than that of said island-like portions, and an area of said fiber-like portions at a membrane surface is set to be larger than that of said island-like portions.
